(19) United States
(12) Patent Application Publication
(10) Pub. No.: US 2024/0089476 A1
(43) Pub. Date: Mar. 14, 2024

(54) VIDEO SWITCHING METHOD AND VIDEO PROCESSING SYSTEM

(71) Applicant: REALTEK SEMICONDUCTOR CORPORATION, Hsinchu (TW)

(72) Inventors: QING LIU, Hunan (CN); ZHAO-DONG YIN, Hunan (CN); MING-RUI LI, Hunan (CN)

(21) Appl. No.: 18/206,300

(22) Filed: Jun. 6, 2023

(30) Foreign Application Priority Data
Sep. 13, 2022 (CN) 202211109435.0

(51) Int. Cl. H04N 19/423; H04N 5/268; H04N 19/172; H04N 19/30; H04N 19/44; H04N 19/463

(52) U.S. Cl. CPC H04N 19/423; H04N 5/268; H04N 19/172; H04N 19/30; H04N 19/44; H04N 19/463

(57) ABSTRACT

A video switching method includes the following operations: decoding second video data during a period when a panel is driven to display image content corresponding to first video data to generate frame parameter data and image data; and processing the image data according to the frame parameter data in response to a control command to drive the panel to display image content corresponding to the second video data.

### BACKGROUND OF THE INVENTION

### 1. Field of the Invention

The present disclosure relates to a video data processing, especially to a video switching method and a video processing system that are able to expedite the video switching speed.

### 2. Description of Related Art

With the development of technology, video sources have become increasingly diversified. For example, video data may be transmitted through digital broadcasting or Internet. In order to display video content from different sources, video displays such as televisions may support displaying multiple videos from various sources. In existing approaches, when a display switches to display different video content, a video processor circuit clears the existing hardware and software setting(s) and then begins decoding the new video content. However, delays be introduced during video switching (e.g., displaying black screen(s)), resulting in a poor user experience and also cannot meet the requirements of Hybrid Broadcast Broadband TV (HbbTV).

### SUMMARY OF THE INVENTION

In some aspects, an object of the present disclosure is to, but not limited to, provide a video switching method and a video processing system that are able to increase the video switching speed.

In some aspects, a video switching method includes the following operations: decoding second video data during a period when a panel is driven to display image content corresponding to first video data to generate frame parameter data and image data; and processing the image data according to the frame parameter data in response to a control command to drive the panel to display image content corresponding to the second video data.

In some aspects, a video processing system includes a first decoder circuit, a second decoder circuit, an access circuit, and a scaler circuit. The first decoder circuit is configured to decode first video data to generate first frame parameter data and first image data. The second decoder circuit is configured to decode second video data to generate second frame parameter data and second image data. The access circuit is configured to selectively output one of the first frame parameter data and the second frame parameter data to be a corresponding frame parameter data and output one of the first image data and the second image data to be a corresponding image data in response to a control command. The scaler circuit is configured to process the corresponding image data according to the corresponding frame parameter data to drive a panel to display image content corresponding to the corresponding image data, in which the second decoder circuit is configured to decode the second video data during a period when the scaler circuit drives the panel to display image content corresponding to the first video data.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of a video processing system according to some embodiments of the present disclosure.

FIG. 2 illustrates a flow chart of a video switching method according to some embodiments of the present disclosure.

FIG. 3 illustrates a flow chart of steps corresponding two operations in FIG. 2 according to some embodiments of the present disclosure.

FIG. 4 illustrates a schematic diagram of timings of image data and output data that are received and outputted by the scaler circuit in FIG. 1 according to some embodiments of the present disclosure.

FIG. 5 illustrates a timing diagram of the image data received and the output data output by the scaler circuit in FIG. 1 according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system implemented with at least one circuit, and the term “circuit” may indicate an object, which is formed with one or more transistors and/or one or more active/passive elements based on a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, similar/identical elements in various figures are designated with the same reference number.

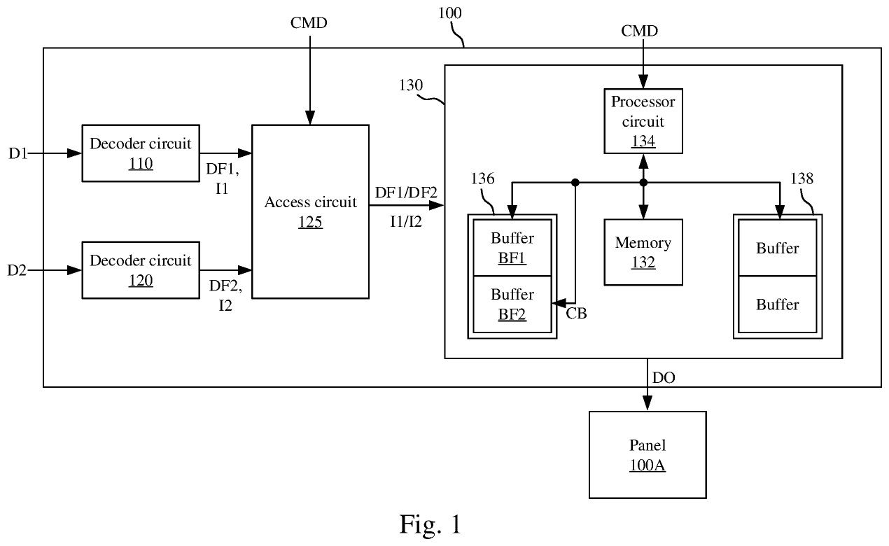

FIG. 1 illustrates a schematic diagram of a video processing system 100 according to some embodiments of the present disclosure. In some embodiments, the video processing system 100 may be applied to an electronic devices having a function of playing video (which may be, for example and not limited to, a television). The video processing system 100 may be configured to process video data D1 and video data D2, in order to drive a panel 100A to display image content corresponding to at least one of the video data D1 and the video data D2. In some embodiments, the video data D1 and the video data D2 may be different data streams. In some embodiments, the video data D1 and the video data D2 may be originated from different signal sources.

The video processing system 100 includes a decoder circuit 110, a decoder circuit 120, an access circuit 125, and a scaler circuit 130. The decoder circuit 110 is configured to decode the video data D1 to generate frame parameter data DF1 and image data I1. In some embodiments, the frame parameter data DF1 includes information about frames in the video data D1, which may include, but not limited, sizes of the frames, a source of the video data D1, and so on. In some embodiments, the image data I1 may include image content corresponding to the video data D1, which may include, but not limited to, pixel data of each frame, and so on. Similarly, the decoder circuit 120 is configured to decode the video data D2, in order to generate frame parameter data DF2 and image data I2. In some embodiments, the frame parameter data DF2 includes information about frames in the video data D2, which may include, but not limited to, sizes of the frames, source of the video data D2, and so on. In some embodiments, the image data I2 may include image content corresponding to the video data D2, which may include, but not limited to, pixel data of each frame, and so on.

The access circuit 125 may selectively output one of the frame parameter data DF1 and/or the frame parameter data DF2 to be a corresponding frame parameter data, and output one the image data I1 and/or the image data I2 to be a corresponding image data, and provide the corresponding frame parameter data and the corresponding image data to the scaler circuit 130 in response to a control command CMD issued from an operating system in the application environment. In some embodiments, the access circuit 125 may adjust the corresponding image data according to input timings accepted by the panel 100A and the corresponding frame parameter data, and transmit the adjusted image data to the scaler circuit 130. In some embodiments, the access circuit 125 may be, but not limited to, a direct memory access (DMA) controller circuit.

The scaler circuit 130 is configured to receive the corresponding frame parameter data and the corresponding image data, and process the corresponding image data according to the corresponding frame parameter data to generate output data DO, and transmit the output data DO to the panel 100A, in order to drive the panel 100A to display the image content corresponding to the video data D1 or the video data D2. For example, in response the control command CMD issued from the operating system in the application environment (which may be, but not limited to, Android), the scaler circuit 130 may receive the frame parameter data DF1 and the image data I1, and process the image data I1 according to the frame parameter data DF1 to generate the output data DO. As a result, the panel 100A may display the image content corresponding to the video data D1. Alternatively, in response to the control command CMD, the scaler circuit 130 may receive the frame parameter data DF2 and the image data I2, and process the image data I2 according to the frame parameter data DF2 to generate the output data DO. As a result, the panel 100A may display the image content corresponding to the video data D2.

In some embodiments, the scaler circuit 130 includes a memory 132, a processor circuit 134, an input register circuit 136, and an output register circuit 138. The memory 132 is configured to store the image data I1 and/or the image data I2. In some embodiments, the memory 132 may be, but not limited to, a dynamic random-access memory or a line buffer. In some embodiments, the scaler circuit 130 may exclude the memory 132, and the image data I1 and/or the image data I2 are stored in other memory in the system.

In some embodiments, the input register circuit 136 may be a double buffer register circuit, in which one buffer BF1 is configured to store the frame parameter data DF1 (or DF2), and another one buffer BF2 is configured to store a control bit CB. The control bit CB may be set by the processor circuit 134 to determine whether the frame parameter data DF1 (or DF2) stored in the buffer FB1 is valid. For example, if the control bit CB has a logic value of 0, it indicates that the frame parameter data DF1 (or DF2) stored in the buffer B1 is invalid. Under this condition, the processor circuit 134 cannot utilize (or read) the frame parameter data DF1 (or DF2) stored in the buffer BF1. Alternatively, if the control bit CB has a logic value of 1, it indicates that the frame parameter data DF1 (or DF2) stored in the buffer BF1 is valid. Under this condition, the processor circuit 134 may read the frame parameter data DF1 (or DF2) stored in the buffer BF1. The processor circuit 134 may process the image data I1 (or I2) according to the read frame parameter data DF1 (or DF2), and transmit the processed the image data I1 (or I2) to the memory 132. In some embodiments, the output register circuit 138 may be, but not limited to, a double buffer register circuit, which has a circuit architecture and operations similar to those of the input register circuit 136. The output register circuit 138 may be configured to read the image data I1 (or I2) processed by the processor circuit 134 from the memory 132, adjust the timing of that image data, and output the adjusted image data to be the output data DO.

In some embodiments, during an interval when the scaler circuit 130 drives the panel 100A to display the image content corresponding to the video data D1 (or the image data I1), the decoder circuit 120 is enabled by the operating system to decode the video data D2 to generate the frame parameter data DF2 and the image data I2. As a result, the access circuit 125 may transmit the frame parameter data DF2 to the buffer BF1 of the input register circuit 136. When the scaler circuit 130 receives the control command CMD, which is for switching to play the video data D2, from the operating system, the processor circuit 134 may set the control bit CB to be the logic value of 1, in order to switch the frame parameter data DF2 stored in the buffer B1 to be valid. Accordingly, the processor circuit 134 may process the image data I2 according to the frame parameter data DF2, in order to drive the panel 100A to start displaying the image content corresponding to the video data D2 (or the image data I2). In other words, before receiving the control command CMD that requests for switching to play the video data D2, the decoder circuit 120 has been started decoding the video data D2. After receiving the control command CMD that requests for switching to play the video data D2, the scaler circuit 130 is able to process the image data I2 according to the frame parameter data DF2 in advance without changing hardware setting(s). As a result, it is able to increase the speed of the panel 100A to display the image content corresponding to the video data D2 (or the image data I2.

In some embodiments, the panel 100A may be switched from displaying the image content corresponding to the video data D1 (or the image data I1) to displaying the image content corresponding the video data D2 (or the image data I2) without displaying black (or blank) screens. In other words, a delay time between displaying the image content corresponding to the video data D1 (or the image data I1) and started displaying the image content corresponding to the video data D2 (or the image data I2) is lower than a predetermined time. In some embodiments, the predetermined time is about equal to or less than 250 milliseconds.

In some related approaches, when the operating system is going to play video data from other source (e.g., in response to a request of a user), the operating system clears related settings of software and hardware, and re-sets those related settings (which may include, as an example, timing, image size, picture quality effect(s), and so on, in which the picture quality effect(s) may include, but not limited to, sharpening, noise reduction, and so on), in order to make a video processor circuit start processing the video data. Thus, during a certain waiting period (approximately 1 second or more) in the switching process, the panel will not display any image content (i.e., displaying a black screen or a white (or blank) screen) until the video processor circuit starts to provide processed video data, at which point it will begin to display the corresponding image content. Compared with the above approaches, in some embodiments of the present disclosure, the decoder circuit 110 (or I20) may bring forward the decoding of the video data D1, and the scaler circuit 130 may process the corresponding image data without changing hardware setting(s), in order to reduce the delay time of the panel 100A. As a result, the panel 100A is able to display almost no black screen (or white screen) during the video switching process, in order to comply with relevant specifications and requirements of existing applications.

In some embodiments, the processor circuit 134 may adjust the image size, resolution, picture quality effect(s), and so on of the image data I1 (or I2) according to the read frame parameter data DF1 (or DF2). In some embodiments, the input register circuit 136 may include a first register (not shown) and a second register (not shown) corresponding to different data domains. The first register may store the image data I1 (or I2) after being processed by the processor circuit 134. The second register may store the processed the image data I1 (or I2) to the memory 132 according to the input timing of the data domain that corresponds to the first register. Similarly, the output register circuit 138 may include a third register (not shown) and a fourth register (not shown) that are corresponding to different data domains. The third register reads the processed image data I1 (or I2) from the memory 132 according to an output timing corresponding to the panel 100A. The fourth register adjusts the image data stored in the third register according to relevant information and required timing of the panel 100A (for example, convert the processed image data I1 (or I2) based on the image format utilized by the panel 100A), in order to generate the output data DO.

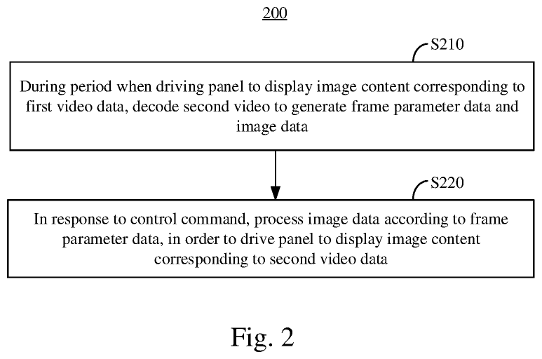

FIG. 2 illustrates a flow chart of a video switching method 200 according to some embodiments of the present disclosure. The video switching method 200 may be, but not limited to, performed by the video processing system 100 in FIG. 1. In operation S210, during a period when the panel is driven to display the image content corresponding to first video data (e.g., the video data D1, second video data (e.g., the video data D2) is decoded to generate frame parameter data (e.g., the frame parameter data DF2) and image data (e.g., the image data I2). In operation S220, in response to a control command, the image data is processed according to the frame parameter data, in order to drive the panel to display the image content corresponding to the second video data.

The above operations of the video switching method 200 can be understood with reference to above embodiments, and thus the repetitious descriptions are not further given. The above description of the video switching method 200 includes exemplary operations, but the operations of the video switching method 200 are not necessarily performed in the order described above. Operations of the video switching method 200 may be added, replaced, changed order, and/or eliminated, or the operations of the video switching method 200 may be executed simultaneously or partially simultaneously as appropriate, in accordance with the spirit and scope of various embodiments of the present disclosure.

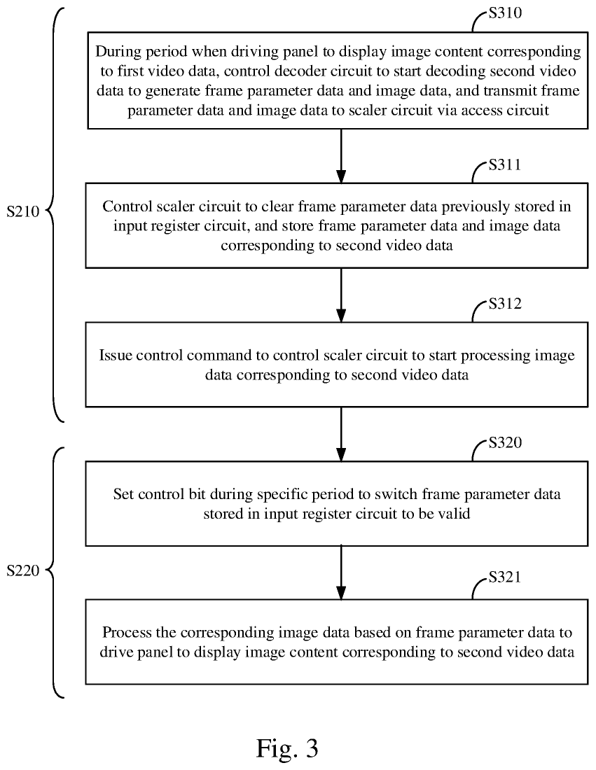

FIG. 3 illustrates a flow chart of steps corresponding operations S210 and S220 in FIG. 2 according to some embodiments of the present disclosure. In this example, operations S210 includes steps S310-S312 (which are mainly performed by the operating system or related application software), and operation S220 includes steps S320-S321 (which are mainly performed by the scaler circuit 130 in FIG. 1).

In step S310, during the period when the panel is driven to display the image content corresponding to the first video data, the decoder circuit is controlled to start decoding the second video data to generate the frame parameter data and the image data, and transmit the frame parameter data (e.g., the frame parameter data DF2) and the image data (e.g., the image data I2) to the scaler circuit (e.g., the scaler circuit 130). In step S311, the scaler circuit is controlled to clear frame parameter data previously stored in the input register circuit (e.g., the input register circuit 136), and store the frame parameter data corresponding to the second video data. In step S312, a control command is issued to control the scaler circuit to start processing the image data corresponding to the second video data.

For example, after the scaler circuit 130 drives the panel 100A to start playing the image content of the video data D1 (e.g., after about 5 seconds), the operating system (or related application software) may control the decoder circuit 120 to start decoding the video data D2 to obtain the frame parameter data DF2 and the image data I2, and control the access circuit 125 to transmit the frame parameter data DF2 to the input register circuit 136 and transmit the image data I2 to the memory 132. Meanwhile, the operating system (or related application software) may control the input register circuit 136 to clear the frame parameter data DF1 previously stored in the buffer BF1. As a result, the buffer BF1 may start storing the frame parameter data DF2. If the operating system (or related application software) issues the control command CMD that requests for displaying the image content corresponding to the video data D2 (or the image data I2), the scaler circuit 130 may start processing the image data I2 corresponding to the video data D2 in response to the control command CMD. It is understood that, in the above step, the operating system (or related application software) does not adjust the original software/hardware settings of the scaler circuit 130, but only adjusts the frame parameter data stored in the scaler circuit 130.

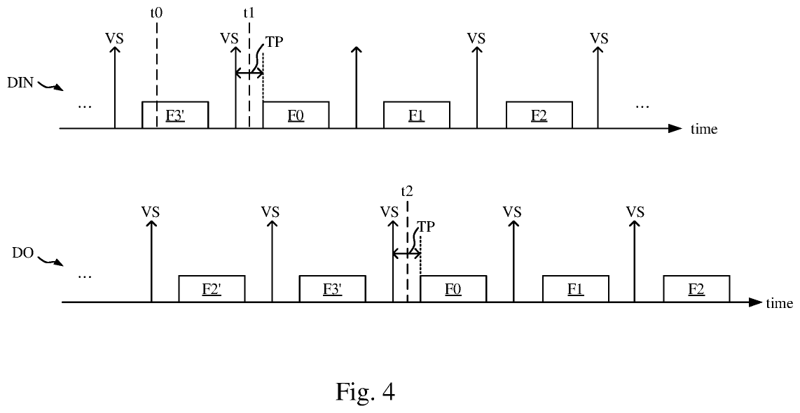

In step S320, a control bit is set during a specific period to switch the frame parameter data stored in the input register circuit to be valid. In some embodiments, this specific period may be an interval between two consecutive frames stored in the scaler circuit 130 (which may be, for example but not limited to, the vertical back porch period TP in FIG. 4). In some embodiments, these two frames are temporally consecutive. In step S321, the corresponding image data is processed based on the frame parameter data to drive the panel to display image content corresponding to the second video data.

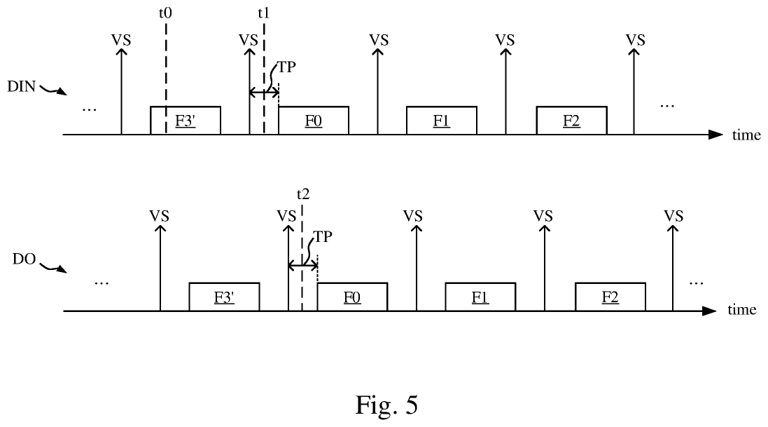

For example, in response to the control command CMD for playing the image content corresponding to the video data D2 (or the image data I2), the processor circuit 134 may set the control bit CB to be a logic value of 1 during the specific period. As a result, the frame parameter data DF2 stored in the buffer BF1 will be switched to be valid, allowing the processor circuit 134 to read the frame parameter data DF2 and process the corresponding image data I2 based on the frame parameter data DF2, thereby driving and switching the panel 100A to display the image content corresponding to the video data D2. In some embodiments, the aforementioned specific period corresponds to a period for displaying non-active image content. In some embodiments, the period for displaying active image content may be multiple frame output periods in FIG. 4, and the period for displaying non-active image content may be period(s) that are non-overlapped with the period for displaying active image content in FIG. 4. For example, the specific period may include, but is not limited to, a vertical front porch period or a vertical back porch period. As a result, it is able to ensure that the panel 100A can display image content normally during the video switching process. Operations discussed herein will be further explained with reference to FIG. 4 and FIG. 5.

FIG. 4 illustrates a schematic diagram of timings of the image data (labeled as DIN) and output data DO that are received and outputted by the scaler circuit 130 in FIG. 1 according to some embodiments of the present disclosure. In FIG. 4, the image data DIN represents either the image data I1 or the image data I2 that is received by the scaler circuit 130. A signal VS is a vertical synchronization (VSync) signal that may be employed to define the frame rate. For example, during the period between two VS signals, the panel 100A may display the image content corresponding to one frame. In the example shown in FIG. 4, the memory 132 may be a dynamic random-access memory (DRAM) and may include first, second, and third storage spaces. The scaler circuit 130 may sequentially write multiple frames from the image data I1 (or image data I2) into the first, second, and third storage spaces. In some embodiments, this dynamic random-access memory may be operated as a frame buffer. Thus, there is at least one frame of delay between the input image data DIN and the output data DO. For example, while the scaler circuit 130 is processing the current frame (i.e., F3′) from the image data I1, the panel 100A displays the image content corresponding to the previous frame (i.e., F2′) from the image data I1.

In this example, prior to time t0, the operating system (or related software) has controlled the decoder circuit 120 to decode video data D2. At time t0, the access circuit 125 stores the frame parameter data DF2 in the buffer BF1. At time T1 in the subsequent vertical back porch period TP (i.e., the period between the signal VS and the next frame), the processor circuit 134 switches the control bit CB to be the logic value of 1, and switches the frame parameter data DF2 stored in the input register circuit 136 to be valid, allowing the scaler circuit 130 to process image data I2 based on the frame parameter data DF2 and sequentially generate multiple frames (sequentially labeled as F0, F1, and F2) corresponding to the video data D2, and the scaler circuit 130 sequentially writes the frames F0, F1, and F2 to the storage space of memory 132. At time t2, the panel 100A may begin displaying the image content corresponding to the frames (sequentially labeled as F0, F1, and F2) of the video data D2 with at least one frame delay.

According to FIG. 4, during the period when the scaler circuit 130 drives the panel 100A to display the image content of the frames corresponding to the video data D1 (for example, from 5 seconds after the scaler circuit 130 starts driving the panel 100A to display the image content corresponding to the video data D1, until time t0), the decoder circuit 120 has started to decode the video data D2. As a result, during the subsequent video switching process, the scaler circuit 130 may process the video data D2 faster to improve the speed of the panel 100A switching to display the image content corresponding to the video data D2.

FIG. 5 illustrates a timing diagram of the image data DIN received and the output data DO output by the scaler circuit 130 in FIG. 1 according to some embodiments of the present disclosure. In examples of FIG. 5, the memory 132 may be, as an example, a line buffer. As a result, there exists only a transfer delay of several rows (or columns) of pixels between the image data DIN and the output data DO, which is significantly lower than the delay of one frame. For example, when the scaler circuit 130 processes the frame F3′ in the image data I1, the panel 100A may display the image content corresponding to the frame F3′ after a shorter delay time (compared with FIG. 4).

In this example, at time t0, the access circuit 125 stores the frame parameter data DF2 in the buffer BF1. During the subsequent vertical back porch period TP, at time t1, the control bit CB is switched to logical value 1 by the processor circuit 134, the frame parameter data DF2 stored in the input register circuit 136 is switched to be valid, allowing the scaler circuit 130 to process the image data I2 based on the frame parameter data DF2 to sequentially generate multiple frames F0, F1, and F2 corresponding to the video data D2. Thus, the panel 100A may start displaying the image content corresponding to the multiple frames F0, F1, and F2 for the video data D2 at time t2.

As described above, the video switching method and video processing system provided in some embodiments of the present disclosure allow decoding another video data in advance and switching the frame parameter data and the image data that are obtained via the decoding to be valid upon receiving a control command for video switching, in order to process the image data corresponding to the other video data without changing hardware setting(s). As a result, the speed of the panel displaying the image content corresponding to the other video data can be accelerated to meet the requirements of existing specification(s).

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A video switching method, comprising:
decoding second video data during a period when a panel is driven to display image content corresponding to first video data to generate frame parameter data and image data; and
processing the image data according to the frame parameter data in response to a control command to drive the panel to display image content corresponding to the second video data.

2. The video switching method of claim 1, wherein the first video data and the second video data are decoded by different decoder circuits.

3. The video switching method of claim 1, wherein decoding the second video data during the period when the panel is driven to display the image content corresponding to the first video data to generate the frame parameter data and the image data comprises:
enabling a decoder circuit to start decoding the second video data during the period, in order to generate the frame parameter data and the image data; and
storing the frame parameter data to a scaler circuit.

4. The video switching method of claim 1, further comprising:
transmitting the frame parameter data to an input register circuit of a scaler circuit, in order to store the frame parameter data; and
setting the frame parameter data to be valid during a specific period in response to the control command, such that the scaler circuit processes the image data according to the frame parameter data to drive the panel to start displaying the image content corresponding to the second video data.

5. The video switching method of claim 4, wherein the specific period includes a vertical front porch period or a vertical back porch period.

6. The video switching method of claim 4, wherein the input register circuit is a double register circuit.

7. The video switching method of claim 4, wherein the scaler circuit starts processing the image data without changing hardware settings.

8. The video switching method of claim 4, wherein the specific period is an interval between two consecutive frames stored by the scaler circuit.

9. A video processing system, comprising:
a first decoder circuit configured to decode first video data to generate first frame parameter data and first image data;
a second decoder circuit configured to decode second video data to generate second frame parameter data and second image data;
an access circuit configured to selectively output one of the first frame parameter data and the second frame parameter data to be a corresponding frame parameter data and output one of the first image data and the second image data to be a corresponding image data in response to a control command; and
a scaler circuit configured to process the corresponding image data according to the corresponding frame parameter data to drive a panel to display image content corresponding to the corresponding image data,
wherein the second decoder circuit is configured to decode the second video data during a period when the scaler circuit drives the panel to display image content corresponding to the first video data.

10. The video processing system of claim 9, wherein the access circuit is a direct memory access controller circuit.

11. The video processing system of claim 9, wherein the second decoder circuit is enabled during the period to start decoding the second video data to generate the second frame parameter data and the second image data, and the scaler circuit comprises an input register circuit that is configured to store the second frame parameter data.

12. The video processing system of claim 11, wherein the input register circuit is a double register circuit.

13. The video processing system of claim 9, wherein the scaler circuit comprises an input register circuit, the input register circuit is configured to store the second frame parameter data, and set the second frame parameter data to be valid during a specific period, such that the scaler circuit processes the second image data according to the second frame parameter data to drive the panel to display the image content corresponding to the second video data.

14. The video processing system of claim 13, wherein the specific period is an interval between two consecutive frames stored by the scaler circuit.

15. The video processing system of claim 13, wherein the specific period comprises a vertical front porch period or a vertical back porch period.

16. The video processing system of claim 13, wherein the scaler circuit starts processing the second image data without changing hardware settings.
